(19) United States
(12) Patent Application Publication
(10) Pub. No.: US 2021/0123192 A1
(43) Pub. Date: Apr. 29, 2021

(54) Adapter for Removing Pin/Lock Spike for Railway Systems

(71) Applicant: Focused Technology Solutions, Inc., Hackettstown, NJ (US)

(72) Inventors: Corey DASH, Mount Arlington, NJ (US); Peter M. Bartek, Ledgewood, NJ (US)

(21) Appl. No.: 17/078,960

(22) Filed: Oct. 23, 2020

Related U.S. Application Data
(60) Provisional application No. 62/924,823, filed on Oct. 23, 2019.

(51) Int. Cl. E01B 29/26

(52) U.S. Cl. CPC E01B 29/26; B25C 11/00

(57) ABSTRACT

A lock spike adapter is disclosed for use with a spike puller to remove a lock spike on a railroad. The lock spike adapter may comprise an adapter portion, a magnet, and a slide pin. The adapter portion may comprise a machine piece of metal and include a top head unit and a pair of arms with a hole through each arm. When the top head unit and the pair of arms of the adapter portion are positioned over the top of a lock spike, the push-through bolt or slide pin may be adapted to slide through the pair of holes in the arms of the adapter portion and the eye of the lock spike. The magnet may be configured to hold the slide pin in place. When attached to a lock spike, the lock spike adapter may be used to pull the lock spike from railroad ties.

### RELATED APPLICATIONS

This application claims priority to U.S. Provisional Patent Application No. 62/924,823, filed Oct. 23, 2019, the content of which is incorporated herein by reference in its entirety.

### FIELD OF THE INVENTION

The present invention relates to rail systems, and, more particularly, to an adapter that fits into a pin or lock spike to allow for easy removal from the tracks of a railway.

### BACKGROUND OF THE INVENTION

Currently, there are limited methods for removing a pin or lock spike from railroad tracks. One current method known and used in the art is to modify a half washer and use a claw bar which can be cumbersome and may cause injury. Most existing and installed spikes are called cut or dog spikes. Most tools, either major machines or hydraulic tools for spike pulling, are made to only remove and pull cut or dog spikes. In the railway industry, again, that means that a claw bar is needed or special equipment is needed to remove the pin or lock spike. In many cases, the current methods break the pin or lock spike keeping it launched into the wood, which may then require a special process to remove the broken pin or lock spike.

### SUMMARY OF THE INVENTION

Aspects of this disclosure relate to a lock spike adapter for use with a spike puller to remove a lock spike on a railroad. The lock spike adapter disclosed herein may comprise an adapter portion, a magnet, and a slide pin. The adapter portion may comprise a machined piece of metal and include a top head unit and a pair of arms with a hole through each arm. When the top head unit and the pair of arms of the adapter portion are positioned over the top of a lock spike, the push-through bolt or slide pin may be adapted to slide through the pair of holes in the arms of the adapter portion and the eye of the lock spike. The magnet may be configured to hold the slide pin in place. When attached to a lock spike, the lock spike adapter may be used to pull the lock spike from railroad ties. When track workers are using powered spike pullers and encounter an outdated spike (e.g., a lock spike), this lock spike adapter may allow them to continue using the spike puller instead of retrieving another tool to deal with the removal of the lock spike.

Additional aspects of this disclosure relate to a method of using a lock spike adapter described herein with a spike puller to remove a lock spike on a railroad. In various embodiments, the method may include the steps of: removing a magnetically held slide pin from an adapter portion of a lock spike adapter, the slide pin sliding through a pair of holes on the adapter portion of the lock spike adapter; placing the adapter portion of the lock spike adapter over the lock spike and aligning the holes on the adapter portion with an eye of the lock spike; sliding the slide pin through the pair of holes on the adapter portion and the eye of the lock spike until a magnet pulls the slide pin in and holds the slide pin in place on the adapter portion; and removing the lock spike with a spike puller by attaching the spike puller to a top head unit of the adapter portion and the lock spike adapter.

These and other objects, features, and characteristics of the invention disclosed herein will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a side view of a lock spike adapter according to one or more aspects described herein;

FIG. 2A depicts a side perspective view of an unassembled lock spike adapter with a lock spike according to one or more aspects described herein;

FIG. 2B depicts a side perspective view of an assembled lock spike adapter with a lock spike according to one or more aspects described herein;

FIG. 2C depicts a side perspective view of the unassembled lock spike adapter with the lock spike according to one or more aspects described herein;

FIG. 2D depicts a side perspective view of the assembled lock spike adapter with the lock spike according to one or more aspects described herein;

FIGS. 3A-D depict various views of an adapter portion of the lock spike adapter according to one or more aspects described herein;

FIG. 4A depicts an exploded top perspective view of the parts of the lock spike adapter according to one or more aspects described herein;

FIG. 4B depicts an exploded side perspective view of the parts of the lock spike adapter according to one or more aspects described herein;

FIG. 5A and FIG. 5B depict various views of a lock spike adapter with example dimensions and measurements according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION OF THE INVENTION

A lock spike adapter and method for using the lock spike adapter with a spike puller to remove a lock spike on a railroad is described herein. The lock spike adapter disclosed herein may comprise an adapter portion, a magnet, and a slide pin. The adapter portion may comprise a machine piece of metal and include a top head unit and a pair of arms with a hole through each arm. When the top head unit and the pair of arms of the adapter portion are positioned over the top of a lock spike, the push-through bolt or slide pin may be adapted to slide through the pair of holes in the arms of the adapter portion and the eye of the lock spike. The magnet may be configured to hold the slide pin in place. When attached to a lock spike, the lock spike adapter may be used to pull the lock spike from railroad ties.

In the following description of various examples of the invention, reference is made to the accompanying drawings, which form a part hereof, and in which are shown by way of illustration various example parts, structures, systems, and steps in which aspects of the invention may be practiced. It is to be understood that other specific arrangements of example parts, structures, systems, and steps may be utilized, and structural and functional modifications may be made without departing from the scope of the present invention. Also, while the terms “top,” “bottom,” “front,” “back,” “side,” “rear,” and the like may be used in this specification to describe various example features and elements of the invention, these terms are used herein as a matter of convenience, e.g., based on the example orientations shown in the figures. Nothing in this specification should be construed as requiring a specific three-dimensional orientation of structures in order to fall within the scope of this invention.

The invention relates to a lock spike adapter and a method for using a lock spike adapter with a spike puller to remove a lock spike on a railroad. The lock spike adapter may include an adapter portion, a slide pin, a magnet, and/or one or more other components. The adapter portion may comprise at least a top head unit and a pair of arms. In various embodiments, the top head unit may be configured to be attached to a spike puller. For example, the top head unit may be sized and shaped to be attached to a spike puller. In various embodiments, the pair of arms may each of comprise a hole. The holes of the two arms may form a pair of holes configured to receive the slide pin. In various embodiments, the slide pin may be adapted to slide through the pair of holes and an eye of a lock spike. In various embodiments, the magnet may be configured to hold the slide pin in place in the adapter portion.

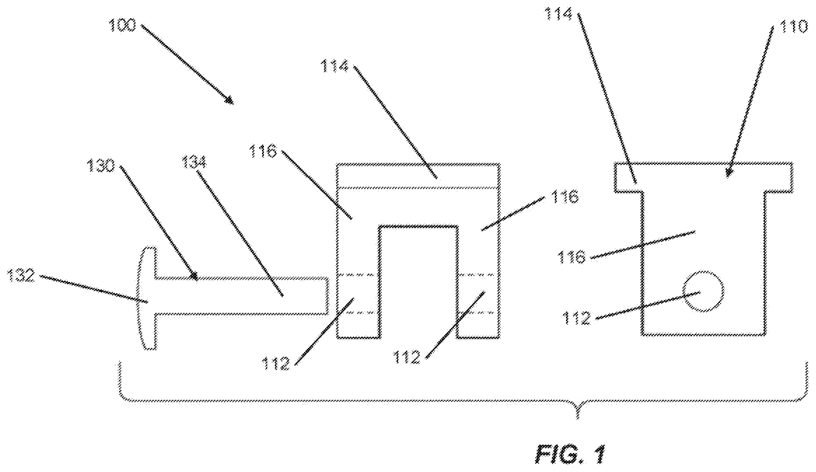

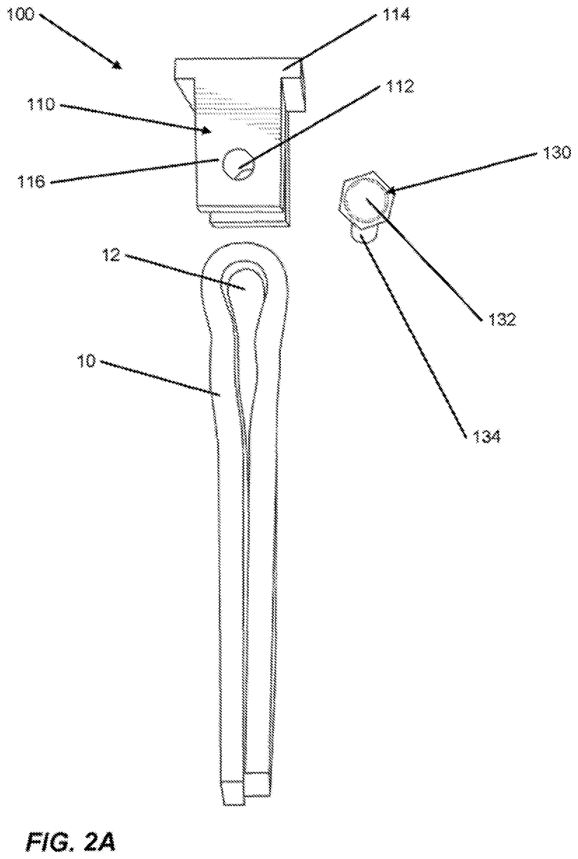

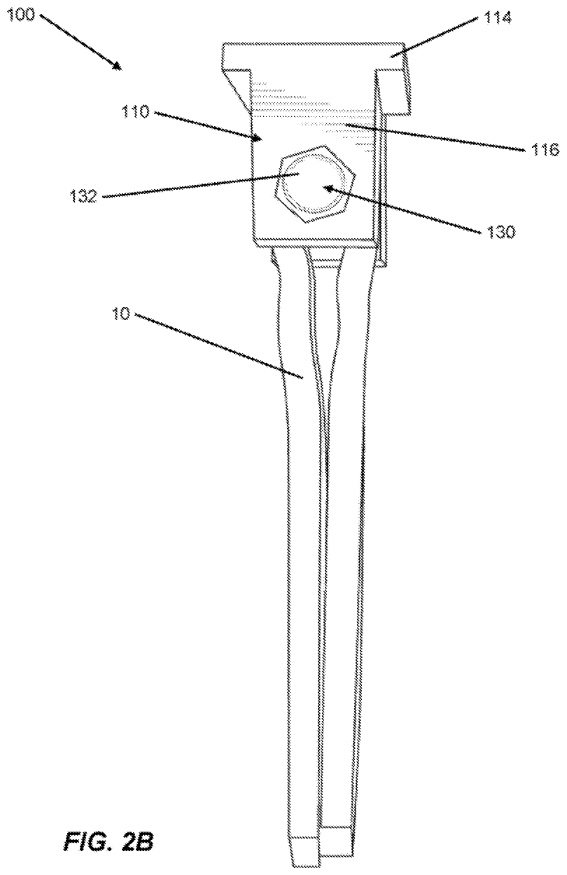

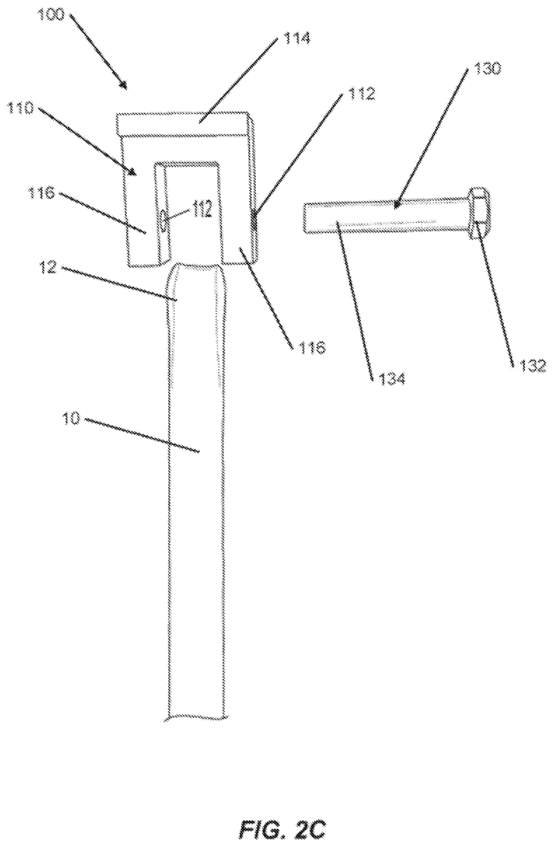

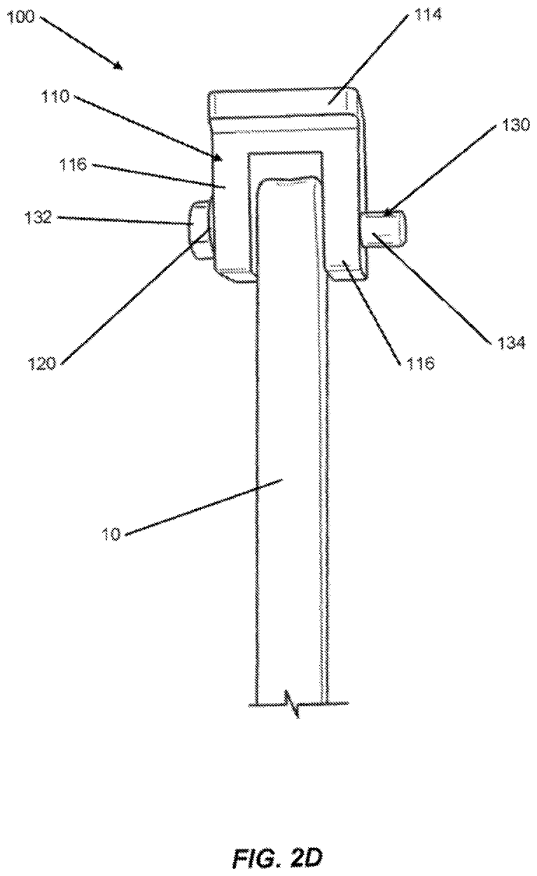

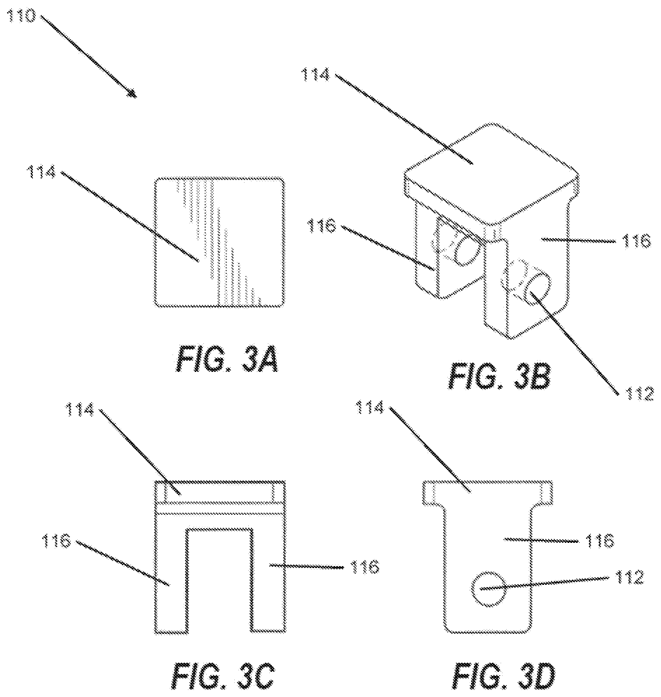

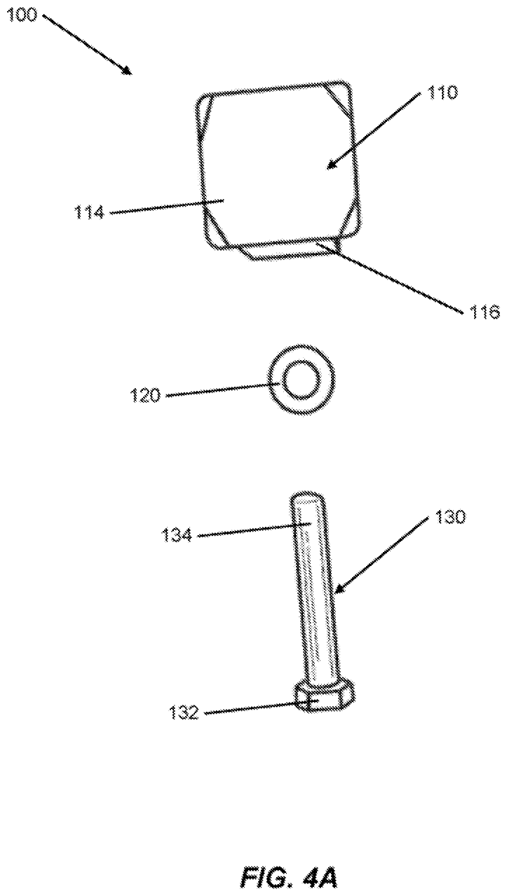

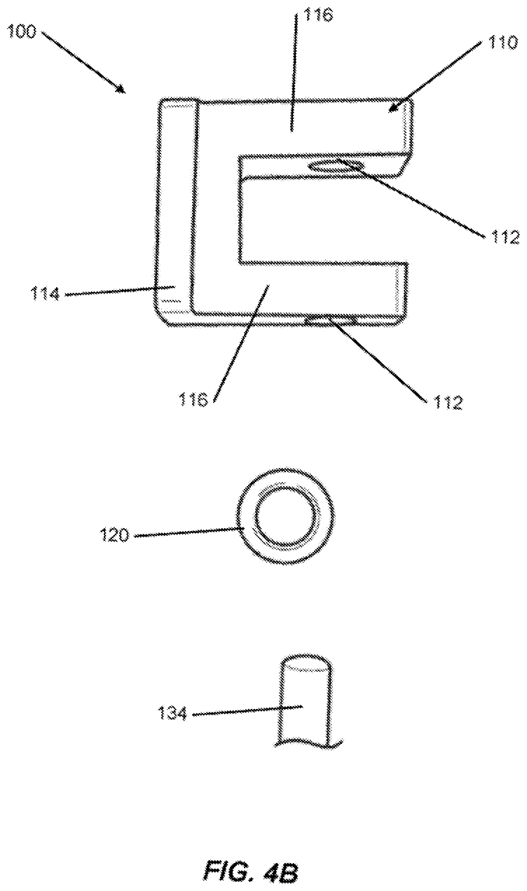

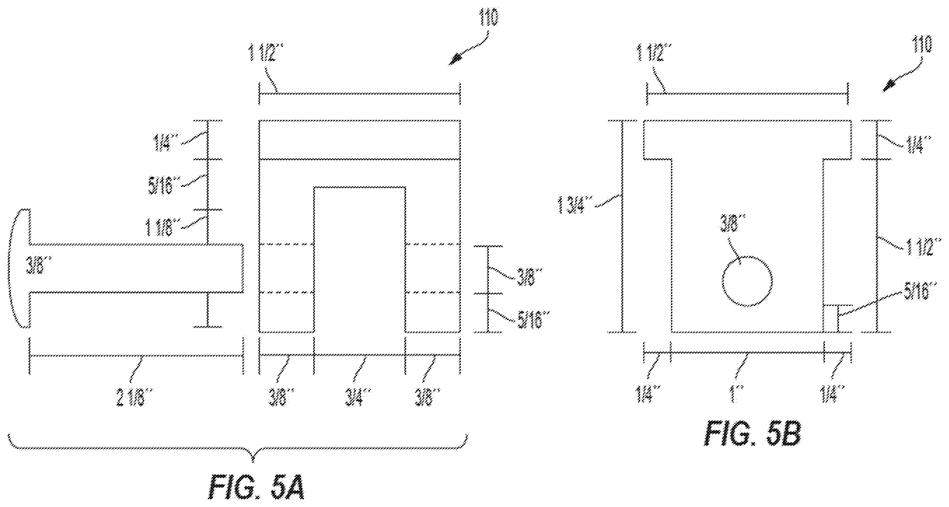

FIGS. 1-5 depict a lock spike adapter 100 that fits into a pin or lock spike 10 to allow easy removal, in accordance with one or more aspects of the invention described herein. FIG. 1 depicts a side view of a lock spike adapter 100. FIG. 2A depicts a side perspective view of an unassembled lock spike adapter 100 with lock spike 10. FIG. 2B depicts a side perspective view of an assembled lock spike adapter 100 with lock spike 10. FIG. 2C depicts another side perspective view of the unassembled lock spike adapter 100 with lock spike 10. FIG. 2D depicts another side perspective view of the assembled lock spike adapter 100 with the lock spike 10. FIGS. 3A-D depict various views of an adapter portion 110 of the lock spike adapter 100. For example, FIG. 3A depicts a top view of an adapter portion 110 of the lock spike adapter 100, FIG. 3B depicts a side perspective view of an adapter portion 110 of the lock spike adapter 100, FIG. 3C depicts a front view of an adapter portion 110 of the lock spike adapter 100, and FIG. 3D depicts a side view of an adapter portion 110 of the lock spike adapter 100. FIG. 4A depicts an exploded top perspective view of the components of the lock spike adapter 100. FIG. 4B depicts an exploded side perspective view of the components of the lock spike adapter 100. FIG. 5A and FIG. 5B depict various views of a lock spike adapter with example dimensions and measurements according to one or more aspects described herein. For example, FIG. 5A depicts an exploded front view of a lock spike adapter with example dimensions and measurements, and FIG. 5B depicts a side view of a lock spike adapter with example dimensions and measurements.

As described herein, lock spike adapter 100 may be configured to use with any pin or lock spike 10 for railways and facilitates the easy removal of any pin or lock spike 10 (including a cut or dog spike) in various railway applications. In various embodiments, lock spike adapter 100 may comprise an adapter portion 110, a magnet 120, a slide pin 130, and/or one or more other components. Adapter portion 110 may comprise a machined metal body and include a top head unit 114 and a pair of arms 116 extending from top head unit 114. In some embodiments, the top head unit 114 of the adapter portion 110 may be adapted to match the look of a cut or dog spike. In some embodiments, lock spike adapter 100 may be configured to enable any battery-operated hydraulic, or machine-operated spike puller to attach to top head unit 114 in order to remove and pull a cut or lock spike 10. In various embodiments, each arm of pair of arms 116 may include a hole 112, thereby forming a pair of holes 112. In various embodiments, the pair of holes 112 may be configured to receive slide pin 130.

In various embodiments, slide pin 120 may be configured to slide through adapter portion 110 and a lock spike (e.g., lock spike 10). For example, slide pin 120 may be configured to slide through the pair of holes 112 of adapter portion 110 and an eye of a lock spike (e.g., eye 12 of lock spike 10). In various embodiments, slide pin 120 may comprise a slide-through bolt or other component configured to be removably inserted into the pair of holes 112 of adapter portion 110. In various embodiments, slide pin 120 may comprise a head portion 132 and a body portion 134 extending from head portion 132. In various embodiments, body portion 134 may be adapted to slide through the pair of holes 112 of adapter portion 110. In various embodiments, lock spike adapter 100 may include a magnet 120 configured to hold slide pin 130 in place. In an example embodiment, body portion 134 of slide pin 130 may be configured to slide through magnet 120 before body portion 134 is slid into the pair of holes 112 of adapter portion 110 and eye 12 of lock spike 10. In the foregoing example embodiment, magnet 120 may be situated between an underside of head portion 132 and an outer side of one arm of the pair of arms 116. Magnet 120 may be magnetically attached to adapter portion 110 and/or slide pin 130 to ensure slide pin does not move or become misplaced.

In various embodiments, top head unit 114 and the pair of arms 116 of adapter portion 110 may be configured to extend over a lock spike 10 and align the pair of holes 112 in the pair of arms 116 of the adapter portion 110 with the eye 12 of lock spike 10. The slide pin 130 may be configured to slide through both the adapter portion 110 and through the lock spike 10. And magnet 120 may be configured to keep the slide pin 130 held in place.

Lock spike adapter 100 may be made or configured to fit onto any pin or lock spike 10. In some embodiments, lock spike adapter 100 may be made or configured to fit onto any pin or lock spike 10 and/or to match the look of any cut or dog spike, thereby allowing the same tools that remove the cut or dog spike to also remove the pin or lock spike 10. In various embodiments, lock spike adapter 100 may be adapted to enable it to be installed quickly (e.g., in approximately two seconds) and easily. For example, lock spike adapter 100 may be specifically adapted in order to enable production to progress without slowing down or require the changing over of any tools or equipment. When the lock spike adapter 100 is attached to an existing pin or lock spike 10, lock spike adapter 100 may be configured to allow any spike puller—e.g., the battery-operated version, a hydraulic version, or a machine version—to easily pull lock spike 10 as if it were a standard cut or dog spike.

In various embodiments, the lock spike adapter 100 described herein may be attached to a lock spike and allow for the easy removal of the locking spikes in the railroad industry. The lock spike adapter 100 may provide an easy way for a track worker to remove a lock spike. The lock spike adapter 100 described herein can be utilized when track workers encounter an outdated spike (e.g., a lock spike) while removing standard cut spikes for maintenance purposes. Instead of retrieving other heavier tools to remove the lock spike, the track worker could use the light-weight lock spike adapter 100 described herein that is configured to work in conjunction with a spike puller already being used.

According to another aspect of the invention, a method for using a lock spike adapter (e.g., lock spike adapter 100) with a spike puller to remove a lock spike from a track of a railway is described herein. In various embodiments, the method for using lock spike adapter 100 may comprise removing the magnetically held slide pin 130 from adapter portion 110. Removing the magnetically held slide pin 130 from adapter portion 110 may comprise sliding the slide pin 130 out of adapter portion 110 via the pair of holes 112 of adapter portion 110. The method may further include placing adapter portion 110 over a lock spike 10 such that the top head unit 114 and the pair of arms 116 extend over lock spike 10 such that the eye 12 of the lock spike 10 is aligned with the pair of holes 112 of the pair of arms 116 of adapter portion 110. The method may further include sliding slide pin 130 through both the pair of holes 112 of the pair of arms 116 of adapter portion 110 and the eye 12 of lock spike 10. In various embodiments, the method may include sliding slide pin 130 through both the pair of holes 112 and the eye 12 of lock spike 10 until magnet 120 pulls the slide pin 130 in and holds the slide pin 130 in place. The method may further include removing the lock spike 10 with a spike puller as if it were a standard cut spike by attaching the spike puller to top head unit 114 of adapter portion 110 of lock spike adapter 100. The steps of the method for using lock spike adapter 100 described herein may be variously combined, separated, removed, reordered, and replaced in a manner other than as expressly described herein. For example, the spike puller may be attached to top head unit 114 of adapter portion 110 before, at the same time as, or after other steps described herein.

The present disclosure is disclosed above and in the accompanying drawings with reference to a variety of examples. The purpose served by the disclosure, however, is to provide examples of the various features and concepts related to the disclosure, not to limit the scope of the invention. It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, one skilled in the relevant art will recognize that numerous variations and modifications may be made to the examples described above without departing from the scope of the present disclosure. Thus, the spirit and scope of the invention should be construed broadly as set forth in the appended claims.

What is claimed is:

1. A lock spike adapter for use with a spike puller to remove a lock spike on a railroad, the lock spike adapter comprising:
an adapter portion comprising a pair of arms and a top head unit configured to be attached to a spike puller, wherein the pair of arms comprises a pair of holes formed by a hole in each arm of the pair of arms;
a slide pin adapted to slide through the pair of holes of the adapter portion and an eye of a lock spike; and
a magnet configured to hold the slide pin in place in the adapter portion.

2. The lock spike adapter of claim 1, wherein the top head unit and the pair of arms extend over the lock spike aligning the pair of holes of the adapter portion and the eye of the lock spike.

3. The lock spike adapter of claim 2, wherein the slide pin is adapted to slide through the pair of holes of the adapter portion and the eye of the lock spike when the pair of holes of the adapter portion are aligned with the eye of the lock spike.

4. The lock spike adapter of claim 1, wherein the slide pin comprises a head portion and a body portion extending from the head portion.

5. The lock spike adapter of claim 4, wherein the body portion of the slide pin is configured to slide through the pair of holes of the adapter portion.

6. The lock spike adapter of claim 4, wherein the magnet is situated between the head portion of the slide pin and an outer side of one of the pair of arms when the body portion of the slide pin is inserted through the pair of holes of the adapter portion and the eye of the lock spike.

7. The lock spike adapter of claim 6, wherein the body portion of the slide pin is configured to slide through the magnet.

8. The lock spike adapter of claim 1, wherein the top head unit of the adapter portion matches a size and shape of a dog spike.

9. The lock spike adapter of claim 1, wherein the spike puller comprises a hydraulic spike puller, a battery-operated spike puller, or a machine-operated spike puller.

10. The lock spike adapter of claim 1, wherein the lock spike adapter is configured to enable the spike puller to remove and pull the lock spike when the spike puller is attached to the top head unit of the adapter portion.

11. A method for removing a lock spike from a track of railway, the method including the steps of:
removing a slide pin from an adapter portion of a lock spike adapter via a pair of holes of the adapter portion, wherein the pair of holes comprise a hole in each of a pair of arms extending from a top head unit of the adapter portion;
placing the adapter portion over a lock spike;
aligning the pair of holes of the adapter portion with an eye of the lock spike;
sliding the slide pin through the pair of holes of the adapter portion and the eye of the lock spike;
attaching a spike puller to the top head unit of the adapter portion of the lock spike adapter; and
removing the lock spike with the spike puller.

12. The method of claim 11, wherein the slide pin is removably held in the adapter portion of the lock spike adapter via a magnet of the lock spike adapter.

13. The method of claim 12, wherein sliding the slide pin through the pair of holes of the adapter portion and the eye of the lock spike comprises sliding the slide pin through the pair of holes of the adapter portion and the eye of the lock spike until the magnet pulls the slide pin in and holds the slide pin in place in the adapter portion.
